(19) United States
(12) Patent Application Publication
(10) Pub. No.: US 2009/0097913 A1
(43) Pub. Date: Apr. 16, 2009

(54) SPACING RIVET, RIVETED JOINT AND METHOD FOR THEIR PRODUCTION

(75) Inventors: Nicolas Begel, Chambery (FR); Hans-Joachim Dembowsky, Hamburg (DE); Johann-Haig Linden, Gutersloh (DE)

Correspondence Address: Hiscock & Barclay, LLP, One Park Place, 300 South State Street, Syracuse, NY, 13202-2078, US

(73) Assignee: Bollhoff Verbindungstechnik GmbH, Bielefeld (DE)

(21) Appl. No.: 12/328,097

(22) Filed: Dec. 4, 2008

Related U.S. Application Data
(62) Division of application No. 11/825,148, filed on Jul. 5, 2007.
Application No. 11/825,148 is a continuation of application No. 11/800,941, filed on May 8, 2007, now abandoned.

(30) Foreign Application Priority Data
May 10, 2006 (DE) 10 2006 021 843.4

(51) Int. Cl. F16D 1/00

(52) U.S. Cl. 403/408.1

(57) ABSTRACT

A riveted joint between two sheet-metal components spaced at a certain distance by means of a spacing rivet is described. The spacing rivet is immobilized on the one sheet-metal component by a flange and a first upset ridge and on the other sheet-metal component by a shoulder and a second upset ridge. A spacing section of the spacing rivet extends between the first upset ridge and the shoulder in order to keep the two sheet-metal components at a certain distance from each other. A spacing rivet and a method for producing this type of riveted joint are also described.

### CROSS REFERENCE TO RELATED APPLICATIONS

This application is a divisional application of U.S. Ser. No. 11/825,148, filed Jul. 5, 2007, which is a continuation application of U.S. Ser. No. 11/800,941, filed May 8, 2007 (now abandoned), which claims the priority of DE 102006021843.4 filed May 10, 2006, the entire contents of which are herein incorporated by reference.

### FIELD OF THE INVENTION

The present invention relates to a riveted joint between a first and second sheet-metal component spaced at a certain distance by means of a spacing rivet, a spacing rivet for this purpose as well as a method for producing the riveted joint.

### BACKGROUND OF THE INVENTION

Connections between two sheet-metal components by means of a blind-rivet nut are known. The blind-rivet nut normally consists of a hollow shaft, which is comprised of a hollow cylindrical upset section for forming an upset ridge and a reinforced thread section. The thread section has an internal thread, into which a tension mandrel of a mounting tool can be bored, in order to form the upset ridge by pulling through the tension mandrel. The two sheet-metal components are hereby clamped between a flange-like head of the blind-rivet nut and its upset ridge. The two sheet-metal components then rest directly against each other.

### SUMMARY OF THE INVENTION

The object of the present invention is to provide a riveted joint between two sheet-metal components, a spacing rivet for this purpose as well as a method for producing the riveted joint, in which the two sheet-metal components are held at a certain distance from each other.

The invention and advantageous embodiments of the invention are defined in the claims.

In the case of a riveted joint designed according to the invention between a first and second sheet-metal component, the spacing rivet is immobilized on the first sheet-metal component by a flange and a first upset ridge and on the other sheet-metal component by a shoulder and a second upset ridge. The distance between the two sheet-metal components is determined by a spacing section of the spacing rivet, which is provided between the two upset ridges.

The spacing rivet for this type of riveted joint is made of a rivet shaft, which has a first sleeve-like upset section with an associated outer flange for forming the first upset ridge, a second sleeve-like upset section with an associated outer shoulder for forming the second upset ridge, and a spacing section between the two upset sections.

The spacing rivet designed according to the invention is an easily producible one-piece part, which enables a reliable and solid connection between the two sheet-metal components while maintaining a certain distance.

The riveted joint designed according to the invention is fast and easy to produce. There are two options:

In accordance with one option, the spacing rivet is inserted into the two sheet-metal components until its flange rests against the first sheet-metal component, and then the two upset sections, preferably in a continuous work process, are folded towards to upset ridges through a relative axial movement of the two sheet-metal components.

In accordance with the other option, the following work steps are provided, which are performed consecutively:

the spacing rivet is inserted into the first sheet-metal component until its flange rests against the first sheet-metal component,

the first upset section of the spacing rivet is folded towards the first upset ridge in order to immobilize the spacing rivet on the first sheet-metal component,

the spacing rivet is inserted into the second sheet-metal component until its shoulder rests against the second sheet-metal component, and

the second upset section of the spacing rivet is folded towards the second upset ridge in order to immobilize the spacing rivet on the second sheet-metal part.

In the last named case, the first two work steps can be performed by the supplier, who then delivers the first sheet-metal component with immobilized spacing rivet to the customer. The customer then performs the other work steps, through which the connection between the two sheet-metal components is established. The work effort required by the customer is reduced accordingly.

Other advantageous embodiments and further developments of the invention arise from the claims.

Exemplary embodiments of the invention are described in greater detail based on the drawings.

### BRIEF DESCRIPTION OF THE DRAWINGS

FIG. 1 shows a partially cut view of a spacing rivet with two sheet-metal components before the joint is produced; and

FIG. 2 shows a view according to FIG. 1 after the joint has been produced.

FIG. 3 shows a view according to FIG. 2 of a spacing rivet, which is surrounded by a bushing-like element.

### DETAILED DESCRIPTION

FIG. 1 shows two sheet-metal components A and B, which concern for example the two shells of a control arm in a shell construction. The two sheet-metal components A and B are permanently joined together by a spacing rivet 2, wherein a certain distance needs to be maintained between the two sheet-metal components.

The spacing rivet 2 is shown in FIG. 1 in its un-deformed state. It consists of a rivet shaft, which comprises an outer flange 4, a hollow cylindrical upset section 6, a spacing section 8 and a hollow cylindrical upset section 12, wherein a surrounding outer shoulder 10 is provided on the outer perimeter of the rivet shaft between the spacing section 8 and the upset section 12.

Similar to conventional blind-rivet nuts, the flange 4 is designed as a flat head, but could also be designed differently, e.g. as a countersunk head.

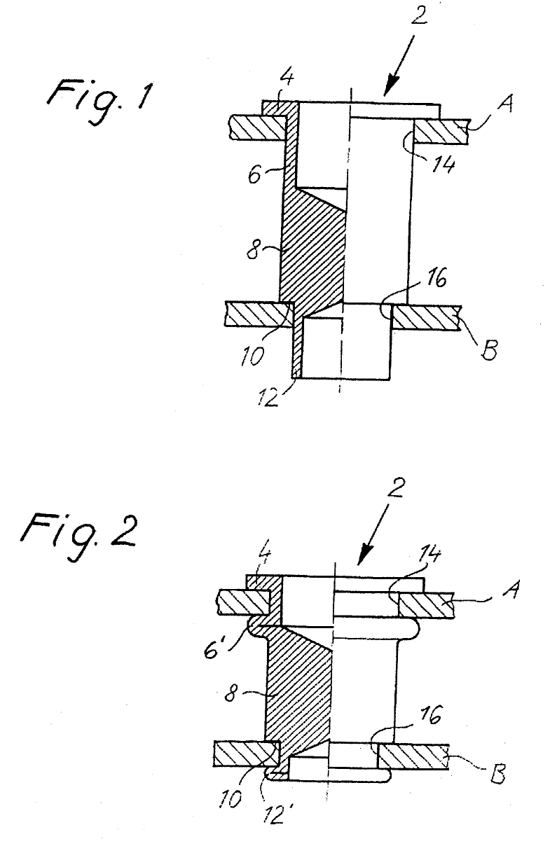

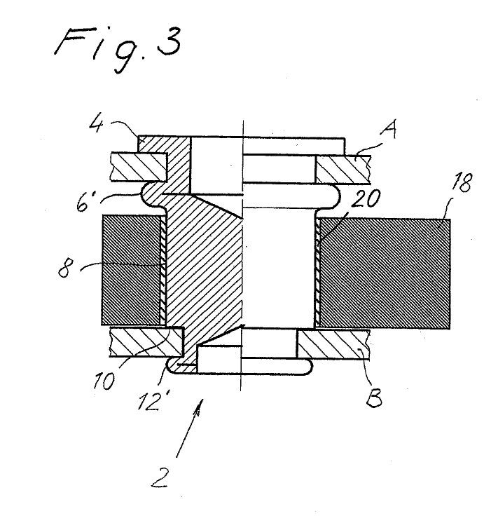

The upset portions 6 and 12 serve to form upset ridges 6′ and 12′ (FIG. 2), as will be explained in greater detail. In the exemplary embodiment shown, the upset section 6 has greater wall strength than the upset section 12, so that the upset section 12 is easier to deform than the upset section 6.

The spacing section 8 is solid and closed in the exemplary embodiment shown. It could also be hollow instead. However, in either case, it should be designed reinforced with respect to the upset sections 6 and 12, so that it is not deformed during the folding of the upset ridges 6′ and 12′.

In the exemplary embodiment shown, the spacing rivet 2 is designed round over its entire outer perimeter. However, it is also possible that it only be round on the outer perimeter in certain areas, for example in the area of the spacing section 8. Instead, it is also possible to design the outer perimeter of the rivet shaft to be non-circular at least in sections, e.g. multi-sided (square or hexagonal), elliptical or in any other non-circular manner.

As already mentioned, the primary function of the spacing rivet 2 is to maintain a distance between components A and B. Moreover, the spacing rivet 2 can also be designed such that it has a functional characteristic for performing an additional function. Thus, for example, it can be provided with a borehole, which is either smooth or provided with an internal thread. The spacing rivet can also be designed as a bolt with or without a thread. It could also be designed as a quick-connect mechanism.

Even if the punching rivet 2 can be provided with an internal thread for performing an additional function, an internal thread is not required to produce the upset ridges 6′ and 12′. In the exemplary embodiment shown, the inside of the punching rivet 12 is thus smooth.

The one-piece punching rivet 2 is made of a malleable material, which enables the production of the upset ridges 6′ and 12′. Steel, stainless steel, aluminum alloys, brass or similar materials, such as those used for blind-rivet nuts, can be used.

There are generally two options for producing the riveted joint shown in FIG. 2:

In accordance with one option, the spacing rivet 2 is inserted into aligning holes 14 and 16 of the two sheet-metal components A and B from one side until the flange 4 rests against sheet-metal component A and the shoulder 10 against sheet-metal component B (FIG. 1). The spacing rivet 2 is then compressed axially using a tool (not shown). For this purpose, the pressing device has e.g. two pressing bodies, one of which attaches to the flange 4 of the spacing rivet 2 and the other to the upset section 12 of the spacing rivet 2. The two pressing bodies of the pressing tool are then moved towards each other axially whereby the upset section 12 is first folded towards the upset ridge 12′ and then the upset section 6 towards the upset ridge 6′. During the upset process, there is a corresponding relative, axial movement between the sheet-metal components A and B so that the distance between the sheet-metal components A, B changes from the state in FIG. 1 by a corresponding amount to the state in FIG. 2. For example, the distance between the two sheet-metal components A, B decreases from approx. 15 mm (FIG. 1) to approx. 13 mm.

After the formation of the upset ridges 6′ and 12′, the sheet-metal component A is clamped between the flange 4 and the upset ridge 6′ and the sheet-metal component B is clamped between the shoulder 10 and the upset ridge 12′. The spacing section 8 ensures a solid and secure connection between the components A and B at the desired mutual distance.

In accordance with the other option, the spacing rivet 2 is first connected only with the sheet-metal component A. For this, the spacing rivet 2 is inserted into the hole 14 of the sheet-metal component A until the flange 4 rests against the sheet-metal component A. Then the upset section 6 is folded towards the upset section 6′ so that the spacing rivet 2 is permanently connected with the sheet-metal component A. The sheet-metal component A and the spacing rivet 2 can now be operated as one structural unit so that a supplier can deliver the structural unit in its current state to a customer.

The customer then performs the rest of the work steps to complete the riveted joint between the sheet-metal components A and B. For this, the upset section 12 of the spacing rivet 2 is inserted into the hole 16 of the sheet-metal component A until the sheet-metal component B rests against the shoulder 10. Then the upset section 12 is deformed into the upset ridge 12′ so that the sheet-metal component B is clamped between the shoulder 10 and the upset ridge 12. The riveted joint between the sheet-metal components A and B is thus complete. It follows that this manner of installation considerably decreases the customer's effort to produce the riveted joint.

In the exemplary embodiment shown in FIGS. 1 and 2, the holes 14, 16 in the components A and B are precast. However, it is also generally possible to provide the spacing rivet 2 with a cutting edge on the end turned away from flange 4. This cutting edge can then be used to punch out the hole 16 of the component B via a corresponding punching procedure during the setting of the rivet 2. Tolerance problems during the alignment of precast holes are hereby avoided.

It is also understood that the upset sections 6 and 12 can also be designed with the same wall strength so that in the case of the first option for producing the riveted joint the two upset ridges 6′ and 12′ are formed at the same time.

In the case of the exemplary embodiment shown in FIG. 3, the riveted joint between the spacing rivet 2 and the components A, B are identical to those in FIG. 2. The only difference is that the spacing section 8 of the spacing rivet 2 is surrounded by a bushing-like element 18. The bushing-like element 18 serves to perform other functions, e.g. as deflection roller, gear wheel, lever arm, etc. It is also possible to provide a bearing sleeve 20, which is effectively “riveted in” during the production of the riveted joint, in the space between the spacing section 8 of the spacing rivet 2 and the bushing-like part 18.

1. A method of producing a riveted joint wherein a first sheet-metal component and a second sheet-metal component are joined by means of a spacing rivet at a predetermined distance from each other, said spacing rivet being in the form of a rivet shaft which has, in an un-deformed state, an outer flange, a first hollow upset section, a second hollow upset section, and a spacing section between said first and second hollow upset sections, an annular shoulder being provided between said second hollow upset section and said spacing section,
said method comprising the following steps:
inserting said rivet shaft into a first hole of said first sheet-metal component until said flange rests against said first sheet-metal component, and said first upset section is folded to form an outwardly bulbed semi-toroidal first upset ridge which clamps said first sheet-metal component against said flange,
inserting said rivet shaft into a second hole of said second sheet-metal component until said annular shoulder rests against said second sheet-metal component, and said second upset section is folded to form an outwardly bulbed semi-toroidal second upset ridge which clamps said second sheet-metal component against said annular shoulder,
said predetermined distance between said first and second sheet-metal components being obtained as a result of said folding steps.

2. The method of claim 1 wherein said steps of inserting said rivet shaft into said first and second holes are performed before the steps of folding said first and second upset sections.

3. The method of claim 2 wherein said first and second upset sections are folded to form said first and second upset ridges in a continuous working process.

4. The method of claim 3 wherein said first upset section is folded to form said first upset ridge by an axial relative movement of said first and second sheet-metal components.

5. The method of claim 1 wherein said steps of inserting said rivet shaft into said second hole and folding said second upset section are performed only after the steps of inserting said rivet shaft into said first hole and folding said first upset section.

6. The method of claim 1 wherein said flange is provided on one axial end of the spacing rivet and said second upset ridge is provided on an opposite axial end of the spacing rivet.

7. The method of claim 1 wherein said first upset section of said rivet shaft has a different wall strength than said second upset section.

8. The method of claim 1 wherein said spacing section of the spacing rivet is rein forced with respect to said first and second upset sections.

9. The method of claim 1 wherein said spacing section is solid.

10. The method of claim 1 wherein said rivet shaft has an outer perimeter which is circular at least in certain areas.

11. The method of claim 1 wherein said rivet shaft has a cutting edge on an axial end remote from said flange for punching said second hole of said second sheet-metal component.

12. The method of claim 1 wherein said spacing section of the spacing rivet is surrounded by a bushing-like element rotatable about a longitudinal axis of the spacing rivet.

13. The method of claim 12 wherein a bearing sleeve is arranged between said spacing section of the spacing rivet and said bushing-like element.
